(19) United States
(12) Patent Application Publication
(10) Pub. No.: US 2006/0055781 A1
(43) Pub. Date: Mar. 16, 2006

(54) Method of processing video data from video presenter

(75) Inventors: Jin-wook Yi, Seongnam-si (KR); Do-jin Kim, Changwon-si (KR)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 11/064,716

(22) Filed: Feb. 23, 2005

(30) Foreign Application Priority Data
Sep. 13, 2004 (KR) 10-2004-0073083
Sep. 13, 2004 (KR) 10-2004-0073084

(51) Int. Cl. H04N 5/225

(52) U.S. Cl. 348/207.1

(57) ABSTRACT

Provided is a method of processing video data in which a computer processes video data received from a video presenter, displays a moving picture, and captures a still picture when a still picture capture signal is generated. The method includes: (a) receiving data of an odd frame; (b) processing and displaying the received data of the odd frame and simultaneously receiving data of an even frame next to the odd frame; (c) processing and displaying the received data of the even frame and simultaneously receiving data of an odd frame next to the even frame; and (d) performing the (b) and the (c) repeatedly and alternately.

### CROSS-REFERENCE TO RELATED PATENT APPLICATIONS

This application claims the priority of Korean Patent Application Nos. 10-2004-0073083 and 10-2004-0073084, both filed on Sep. 13, 2004, in the Korean Intellectual Property Office, the disclosures of which are incorporated herein in their entireties by reference.

### BACKGROUND OF THE INVENTION

1. Field of the Invention

The present invention relates generally to a video presenter, and more particularly to a method of processing video data in which a computer processes video data received from a video presenter, displays a moving picture, and captures a still picture when a still picture capture signal is generated.

2. Description of the Related Art

A conventional video presenter is, for example, disclosed in U.S. Pat. No. 5,822,013. The conventional video presenter provides a computer with video data via a serial transmission and the computer processes the video data to displays a moving picture. Further, the disclosed video presenter captures a still picture when a still picture capture signal is generated.

A high-speed serial transmission protocol, for example, a universal serial bus (USB) 2.0 protocol capable of 480 Mbps data transmission, is used between the computer and the video presenter so the video presenter can transmit video data to the computer at high speed. For example, the video presenter can transmit video data as an extended graphics array (XGA) with a resolution of 1,024×768 pixels at a speed of 20 frames per second (FPS).

However, since the computer requires time to receive and process video data that is continuously input at high speed, it is very difficult to completely receive and process video data, and display the moving picture. Therefore, although the video presenter can transmit video data to the computer at high speed, the moving picture displayed on a monitor of the computer has poor quality.

### SUMMARY OF THE INVENTION

The present invention provides a method of processing video data in which a computer completely receives and processes video data that are input from a video presenter at high speed so as to display a moving picture.

According to an aspect of the present invention, there is provided a method of processing video data in which a computer processes video data received from a video presenter, displays a moving picture, and captures a still picture when a still picture capture signal is generated.

The invention provides a method wherein adjacent frames of the video data are processed in parallel. That is, an odd frame of the video data is received while an adjacent even frame of the video data is processed, and vice versa, so that the receiving speed and processing speed of video data are doubled so that the computer can display the moving picture received from the video presenter.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view illustrating a video presenter and a computer that executes a video data processing program according to an embodiment of the present invention;

FIG. 2 is a block view illustrating the structure of the video presenter shown in FIG. 1;

FIG. 3 is a flow chart describing the video data processing program that is executed by the computer shown in FIG. 1, according to an embodiment of the present invention;

FIG. 4 is a flow chart describing an algorithm to display a moving picture in FIG. 3;

FIG. 5 is a flow chart describing in detail the algorithm to display a moving picture in FIG. 3;

FIG. 6 is a flow chart describing in detail an algorithm to capture a still picture in FIG. 3;

FIG. 7 is a flow chart describing an algorithm to capture a moving picture in FIG. 3; and

FIG. 8 is a flow chart describing in detail the algorithm to capture the moving picture in FIG. 3.

### DETAILED DESCRIPTION OF THE INVENTION

Hereinafter, various embodiments of the present invention will be described in detail with reference to the attached drawings.

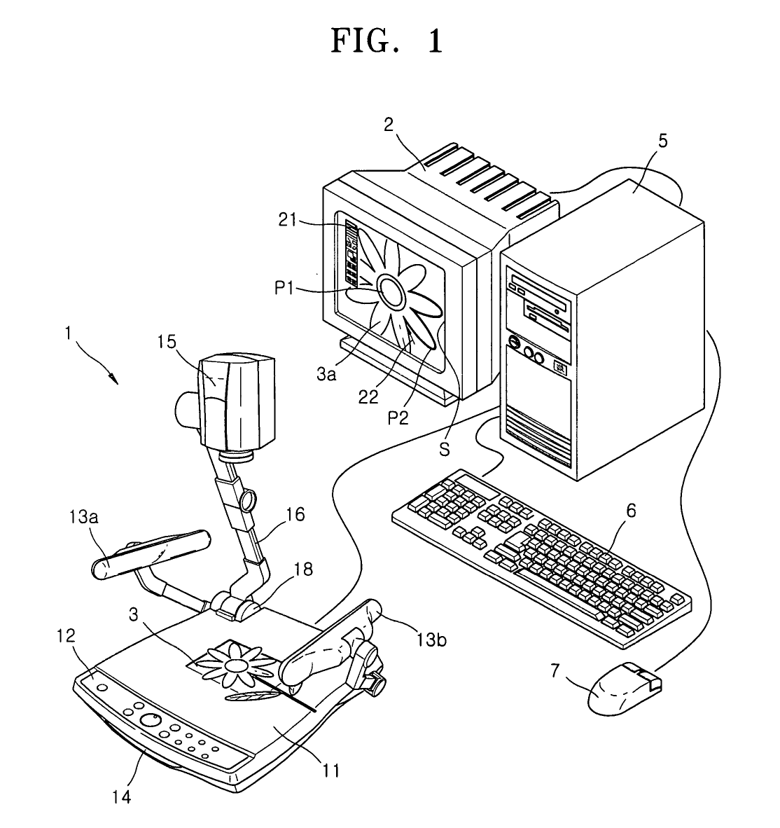

FIG. 1 is a perspective view illustrating a video presenter and a computer that executes a video data processing program according to an embodiment of the present invention. Referring to FIG. 1, the video presenter 1 comprises a video sensor 15, illumination devices 13a and 13b, a pole brace 16, a locking button 18, a subject panel 11, a key input device 12, and a remote receiving device 14.

The video sensor 15, which is capable of moving front and back, up and down, and rotating, comprises an optical system and a photoelectric converter. The optical system that processes light from a subject comprises a lens unit and a filter unit. The photoelectric converter such as a charge coupled device (CCD) or a complementary metal-oxide-semiconductor (CMOS), converts light incident from the subject using the optical system into an electric analog signal.

A user presses the locking button 18 to move the pole brace 16. Another illumination device is embedded in the subject panel 11. The key input device 12 is used to control a drive of the video sensor 15, the illumination devices 13a and 13b, and other features of the video presenter 1 by a user's manipulation. The user inputs a control signal to the remote receiving device 14 by operating a remote transmitting device (not shown), thereby controlling a drive of the video sensor 15, illumination devices 13a and 13b and other features of the video presenter 1, remotely.

The computer 5 that executes the video data processing program, i.e., an exclusive program of the video presenter 1, processes video data received from the video presenter 1 to display a moving picture on the display screen S of a monitor 2. Further, the computer 5 captures a still picture from the received video data when a user generates a still picture capture signal via the video presenter 1, and again displays the moving picture when a moving picture capture signal is generated. To this end, the main control unit of the video presenter 1 communicates with the computer 5 via an interface using a high-speed serial transmission protocol, i.e., a universal serial bus (USB) 2.0 protocol capable of 480 Mbps data transmission format. The video presenter 1 can transmit video data via the interface in an extended graphics array (XGA) with a resolution of 1,024×768 pixels at a speed of 20 frame per second (FPS).

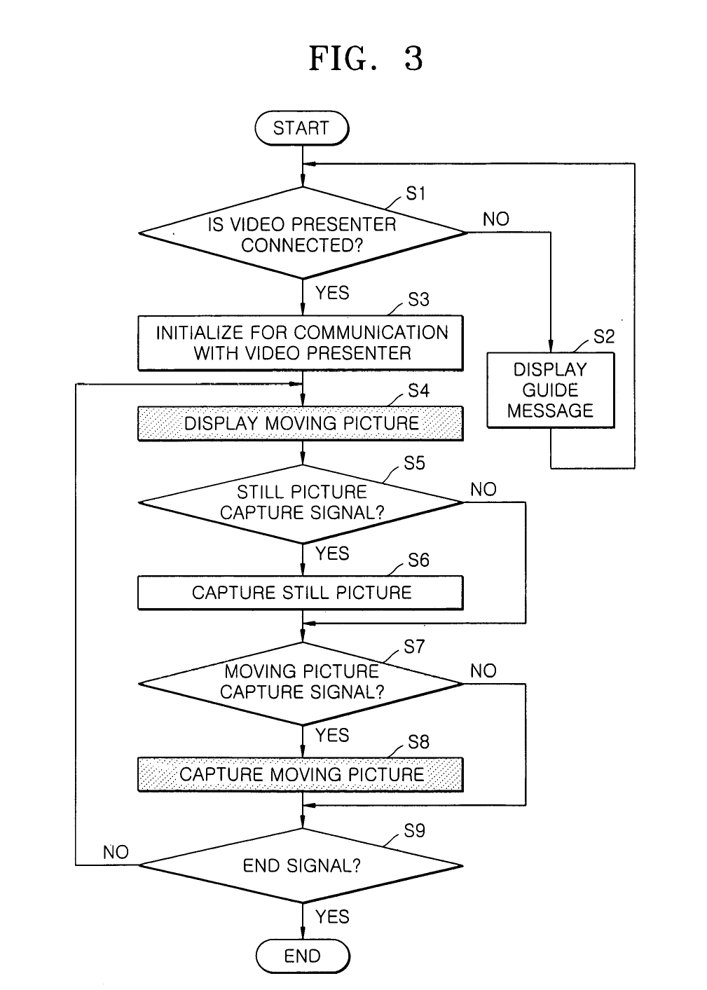

The computer 5 receives and processes video data from the video presenter 1 and displays the moving picture on the display screen S of the monitor 2. The moving picture of a subject 3 on the subject panel 11 is displayed on the display screen S of the monitor 2. The computer 5 captures the still picture from the video presenter 1 according to the still picture capture signal from the user. The computer 5 captures the moving picture from the video presenter 1 according to the moving picture capture signal from the user (see FIG. 3).

The user can edit the still picture and moving picture from the video presenter 1 while executing the video data processing program. A painting board 21 is displayed on the display screen S of the monitor 2. The user can draw pictures P1 and P2 in duplicate on a subject video 3a using a mouse 7, a keyboard 6, and the painting board 21, resulting in a variety of displays. Reference numeral 22 of FIG. 1 indicates a pointer directed by the mouse 7 in communication with the computer 5.

Alternatively, when the user does not desire or expect to edit the video data received from the video presenter 1 by using the computer 5, the video data output from the video presenter 1 can be directly input to the monitor 7.

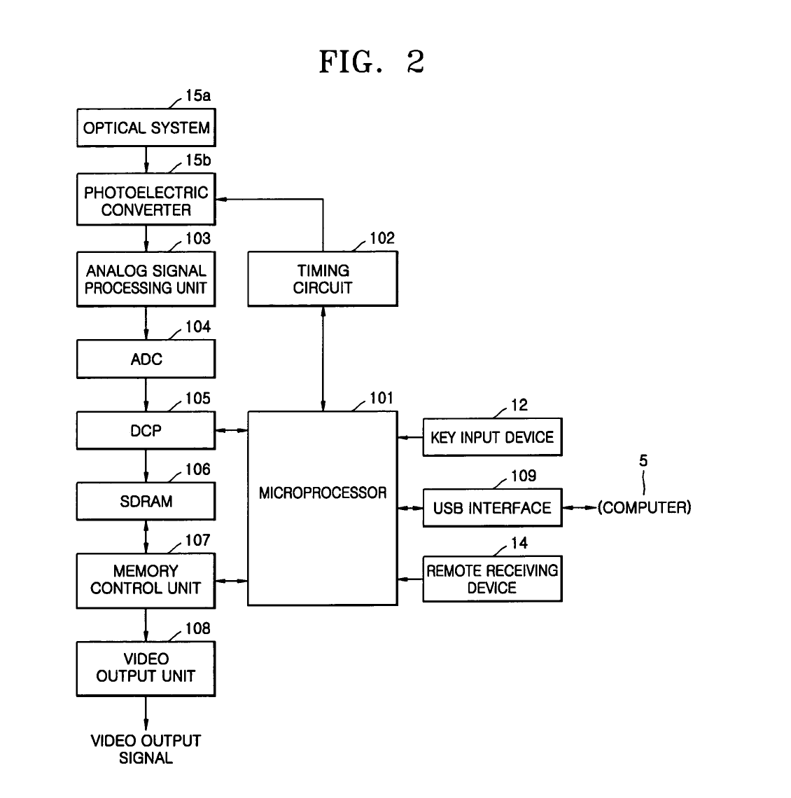

FIG. 2 is a block view illustrating the structure of the video presenter shown in FIG. 1. Referring to FIG. 2, the video presenter 1 comprises the key input device 12, the remote receiving device 14, a USB interface 109, an optical system 15a, a photoelectric converter 15b, an analog signal processing unit 103, an analog-digital converter 104, a digital camera processor 105, a timing circuit 102, a microprocessor 101 as a main control unit, a synchronous dynamic random access memory (SDRAM) 106 as frame memory, a memory control unit 107, and a video output unit 108. Like reference numerals in FIGS. 1 and 2 denote like elements.

The optical system 15a optically processes light from the subject 3. The photoelectric converter 15b such as CCD or CMOS converts light incident from the optical system 15a into an electric analog signal. The timing circuit 102 controlled by the microprocessor 101, i.e., a timing generator device controls the photoelectric converter 15b. The analog signal processing unit 103, e.g., a correlation double sampler and automatic gain controller (CDS-AGC) unit, processes an analog signal from the photoelectric converter 15b, removes a high frequency noise of the analog signal, and adjusts an amplitude of the analog signal. The analog-digital converter 104 converts the analog signal from the analog signal processing unit 103 into a digital signal of R (Red), G (Green), and B (Blue). The digital camera processor 105 processes the digital signal from the analog-digital converter 104 and generates video data in a “Y:Cb:Cr 4:2:2” format, a well known format for luminance and chromaticity.

The SDRAM 106 stores the video data of the digital camera processor 105 in frame units. The memory control unit 107 composed of a field programmable gate array (FPGA) provides the video output unit 108 with frame data from the SDRAM 106 while selectively inputting the frame data to the microprocessor 101. The microprocessor 101 communicates with the computer 5 via the USB interface 109, and transmits the frame data from the memory control unit 107 to the computer 5, which is required by the computer 5.

The video output unit 108, e.g., a video graphics array (VGA) engine unit, converts and outputs the video data from the memory control unit 107 into an analog composite video signal. When the video presenter 1 is directly connected to the monitor 2, the analog composite video signal from the video output unit 108 is directly input in the monitor 2. The microprocessor 101 controls the timing circuit 102 and digital camera processor 105 according to a signal from the key input device 12 and remote receiving device 14.

FIG. 3 is a flow chart describing the video data processing program executed by the computer shown in FIG. 1, according to an embodiment of the present invention. Referring to FIGS. 1 to 3, the video data processing program executed by a central processing unit (CPU) of the computer 5, according to an embodiment of the present invention will now be described.

In Operation S1, the microprocessor 101 determines if the USB interface 109 of the video presenter 1 and a USB interface (not shown) of the computer 5 are connected to each other. When not connected, in Operation S2, a guide message is displayed (e.g., on the monitor 2 when the video output unit 108 is connected with the monitor 2). When connected the video presenter 1 and the computer 5 are interconnected by their respective USB interfaces video data is processed as below.

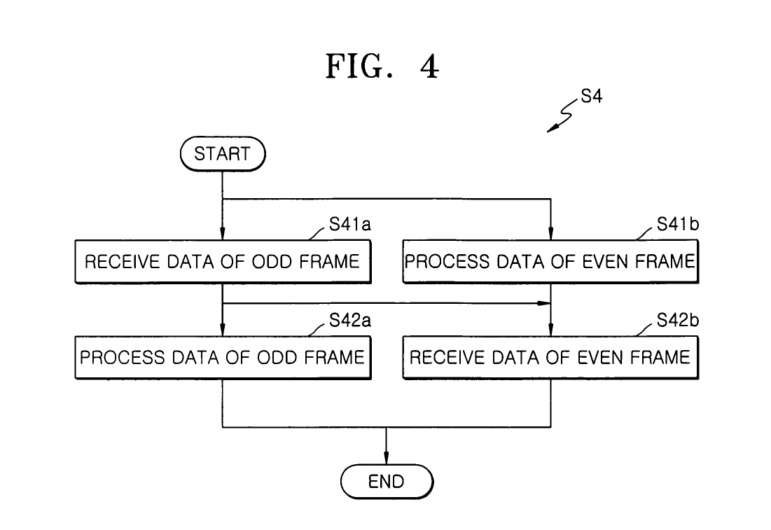

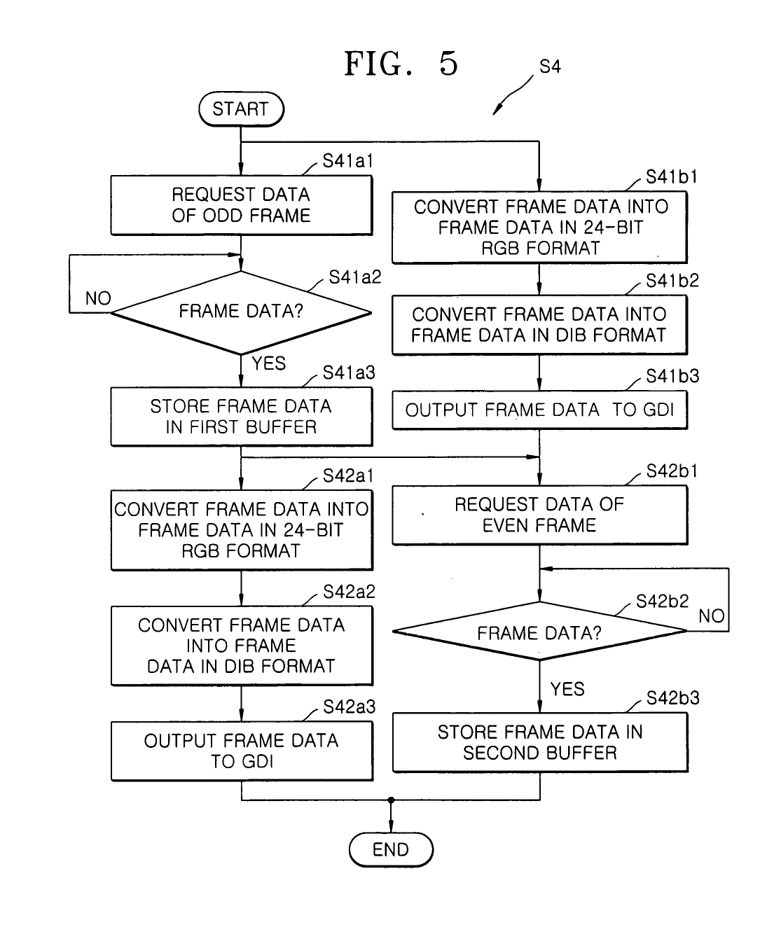

In Operation S3, the computer 5 (e.g., buffers and the like thereof) is initialized for USB communication with the video presenter 1. In Operation S4, USB communication is performed with the video presenter 1 and data of consecutive frames from the video presenter 1 is processed so that a moving picture of the subject 3 is displayed. In this regard, by alternately receiving and processing an odd frame and an even frame, respectively, and vice versa, the receiving speed and the processing speed of video data double so that the computer 5 can display the moving picture on the monitor 2 by completely receiving and processing the video data input from the video presenter 1 at high speed. When the moving picture is displayed in Operation S4, an algorithm by which data of a single frame is processed will be described in further detail hereinafter with reference to FIGS. 4 and 5.

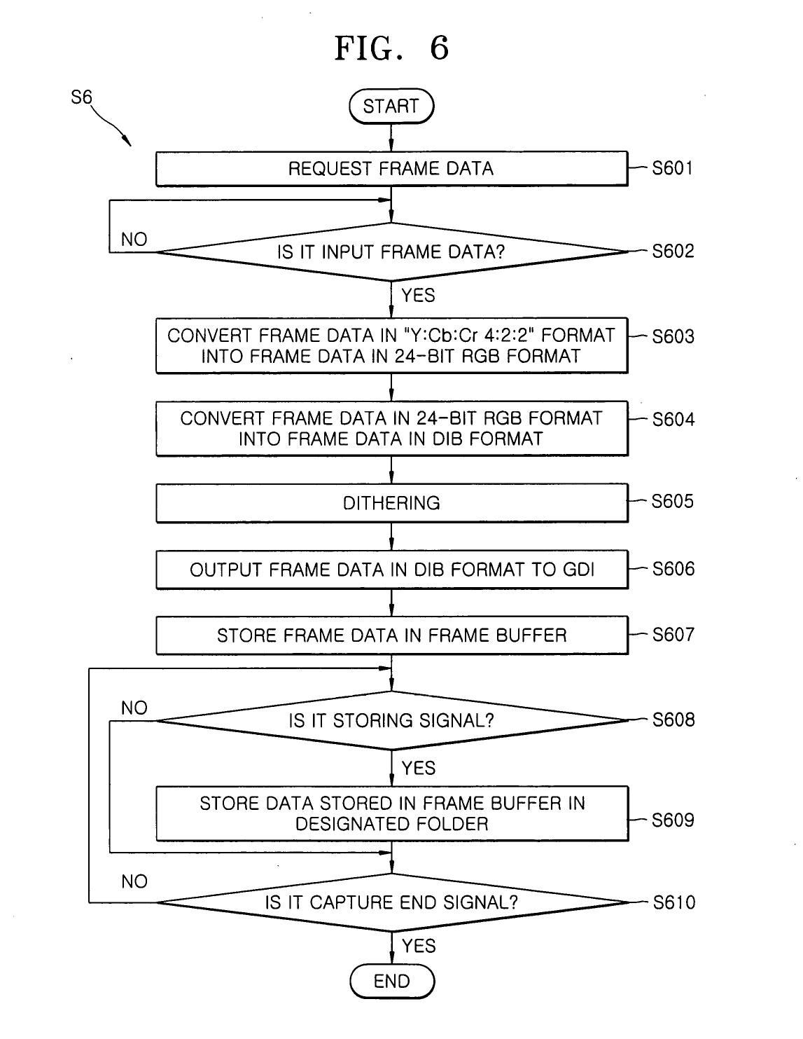

When the still picture capture signal is generated in Operation S5 while the moving picture is displayed (e.g., when the user presses a button on the key input device 12 or the remote receiving device 14), data of a single frame from the video presenter 1 is processed and the still picture is captured in Operation S6. When the still picture is captured in Operation S6, an algorithm by which data of the single frame is processed will be described in further detail hereinafter with reference to FIG. 6.

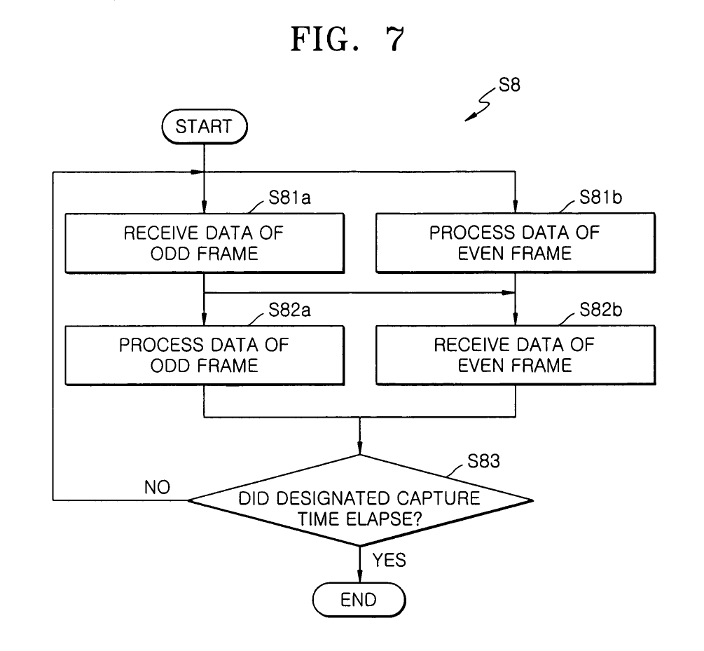

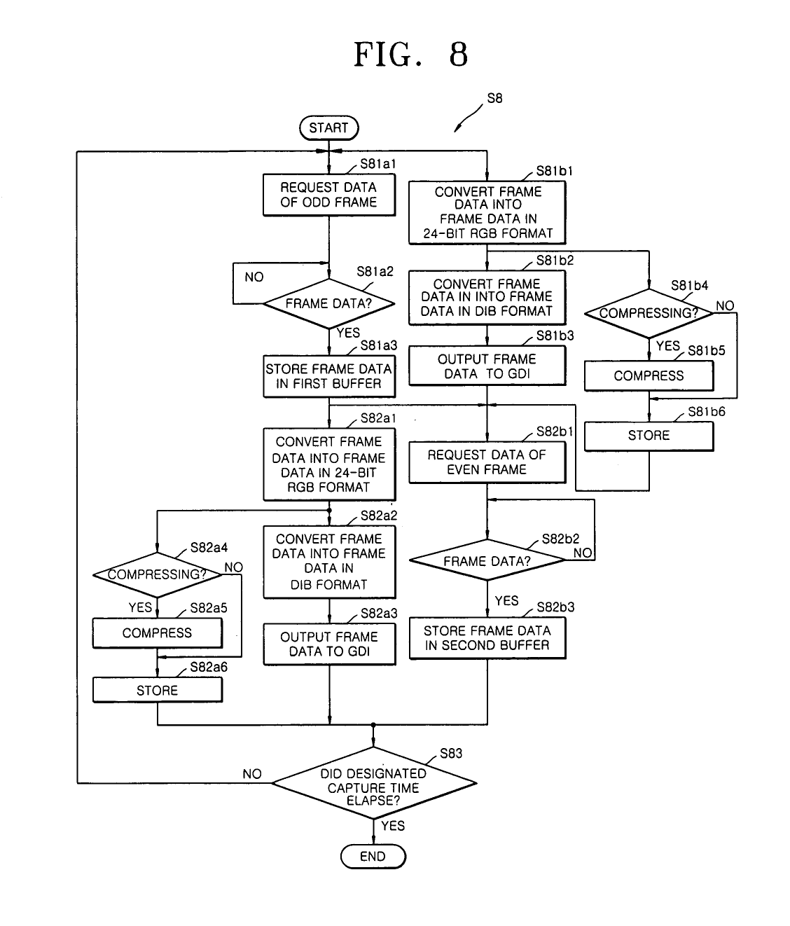

When the moving picture capture signal from the user is generated while the moving picture is displayed in Operation S7, data of consecutive frames from the video presenter 1 is processed and the moving picture is captured in Operation S8. In this regard, alternately receiving and processing an odd frame and even frame results in a double performance and double speedy performance so that the computer 5 can capture the moving picture by completely receiving and processing the video data input from the video presenter 1 at high speed. When the moving picture is displayed in Operation S8, an algorithm by which data of the moving picture is processed will be described in further detail hereinafter with reference to FIGS. 7 and 8.

In Operation S9, the Operations S4 through S8 are repeated until an end signal is input. To be more specific, while the computer 5 is neither operating to capture a still picture nor operating to capture a moving picture, the moving picture from the video presenter 1 is repeatedly displayed in Operation S4. A parallel processing of two adjacent frames makes it possible to display the moving picture.

FIG. 4 is a flow chart describing an algorithm to display a moving picture (e.g., operation S4 in FIG. 3). Referring now to FIGS. 1 and 4, the algorithm performed in Operation S4 in FIG. 3 will be described by separating it into a first flow and subsequent flows.

In the first flow of the algorithm, the CPU of the computer 5 receives data of an odd frame from the video presenter 1 in Operation S41a. The CPU of the computer 5 processes the received data of the odd frame in Operation S42a and thereafter displays the received and processed odd frame data. Simultaneously with the processing and display of the odd frame data in Operation S42a, the CPU of the computer 5 receives data of an even frame in Operation S42b, the even frame being adjacent (i.e., proceeding or following) the odd frame. Further, as illustrated, the CPU of the computer 5 processes and displays in Operation S41b the received data of another adjacent even frame to the odd frame simultaneously with the odd frame data receiving in Operation S41a. To this end, the CPU is capable of receiving data from one frame while simultaneously processing and displaying data from another frame. Thus, the data processing efficiency of the computer is increased since the CPU essentially parallel processes adjacent data frames of the image data.

The algorithm makes it possible to receive and process the odd frames while respectively processing and receiving the even frames, and vice versa so that the computer 5 can display the moving picture on the monitor 2 when receiving a high speed video data input signal from the video presenter 1.

FIG. 5 is a flow chart describing in further detail the algorithm to display a moving picture. Operations S41a1, S41a2, and S41a3 of FIG. 5 are included in Operation S41a in FIG. 4. Similarly, Operations S41b1, S41b2, and S41b3 of FIG. 5 are included in Operation S41b of FIG. 4, Operations S42a1, S42a2, and S42a3 of FIG. 5 are included in Operation S42a, and Operations S42b1, S42b2, and S42b3 of FIG. 5 are included in Operation S42b. Referring to FIGS. 1, 2, 4, and 5, it will now be described in detail how the moving picture is displayed.

The left-hand flow of FIG. 5 first illustrates the data receiving operation of an odd frame (i.e., Operation S41a of FIG. 4). As shown, the CPU of the computer 5 requests data of the odd frame from the microprocessor 101 of the video presenter 1 in Operation S4a1. In response to the foregoing request the microprocessor 101 of the video presenter 1 controls the memory control unit 107 and transmits completed format frame data from the memory control unit 107 to the computer 5 via the USB interface 109. The CPU of the computer 5 receives the data of the odd frame from the video presenter 1 and stores frame data in the “Y:Cb:Cr 4:2:2” format in a first buffer in Operations S41a2 and S41a3.

The right-hand flow of FIG. 5 illustrates the data processing of an even frame (i.e., Operation S41b of FIG. 4) that occurs simultaneously with the foregoing described receiving the data of an adjacent odd frame. As shown, the CPU of the computer 5 converts the frame data in the “Y:Cb:Cr 4:2:2” format, which is stored in a second buffer, into frame data in a 24-bit red-green-blue (RGB) format in Operation S41b1. The CPU of the computer 5 next converts the frame data from the 24-bit RGB format into frame data in a device independent bitmap (DIB) format in Operation S41b2 in order to be used in a graphic device interface (GDI) of an operating system (OS) of the computer 5. The CPU of the computer 5 then outputs the frame data, which is now in the DIB format, to the GDI in Operation S41b3. The OS of the computer 5 displays completed format frame data from the video presenter 1.

During the processing of data in the odd frame (i.e., Operation S42a of FIG. 4), the CPU of the computer 5 converts the frame data in the “Y:Cb:Cr 4:2:2” format stored in the first buffer into the frame data in the 24-bit RGB format in Operation S42a1. The CPU of the computer 5 next converts the frame data in the 24-bit RGB format into the frame data in the DIB format in Operation S42a2 in order to be used in the GDI of the OS of the computer 5.

The CPU of the computer 5 outputs the frame data in the DIB format to the GDI in Operation S42a3. The OS of the computer 5 displays completed format frame data from the video presenter 1.

In receiving data of an even frame (i.e., Operation 42b of FIG. 4 occurring simultaneously with Operation S42a) the CPU of the computer 5 requests data of the even frame in Operation S42b1 from the microprocessor 101 of the video presenter 1. In response, the microprocessor 101 of the video presenter 1 controls the memory control unit 107, and transmits completed format frame data from the memory control unit 107 to the computer 5 via the USB interface 109. The CPU of the computer 5 receives data of the even frame from the video presenter 1 and stores the even frame data in the “Y:Cb:Cr 4:2:2” format in a second buffer in Operations S42b2 and S42b3.

FIG. 6 is a flow chart describing an algorithm to capture a still picture according to operation S6 in FIG. 3. Referring to FIGS. 1, 2, and 6, when the still picture is captured, an algorithm to process frame data will now be described in detail.

As shown in FIG. 6, the CPU of the computer 5 requests frame data in Operation S601 from the microprocessor 101 of the video presenter 1. In response, the microprocessor 101 of the video presenter 1 controls the memory control unit 107 and transmits completed format frame data from the memory control unit 107 to the computer 5 via the USB interface 109.

The CPU of the computer 5 receives completed format frame data from the video presenter 1 in Operation 602, and converts the frame data in the “Y:Cb:Cr 4:2:2” format into the frame data in the 24-bit RGB format in Operation S603. The CPU of the computer 5 next converts the frame data in the 24-bit RGB format into the frame data in the DIB format in Operation S604 in order to be used in the GDI of the OS of the computer 5.

Video reproducibility may be deteriorated due to a conversion of frame data to the 24-bit RGB format in Operation S603. In response, the CPU of the computer 5 performs dithering in Operation S605 for the completed format frame data, which is in the DIB format. In this regard, dithering is a well-known video processing method such as digital halftoning or the like and requires no further explanation.

Then, the CPU of the computer 5 outputs the frame data in the DIB format to the GDI in Operation S606. The OS of the computer 5 subsequently displays completed format frame data from the video presenter 1.

In Operation S607 the CPU of the computer 5 stores the frame data in the DIB format to a frame buffer. In Operation S608 the CPU of the computer 5 awaits a storing signal or capture end signal from the user. Once the CPU has detected the storing signal the CPU proceeds to store data from the frame buffer to a folder designated by the user in Operation S609. When the user inputs the capture end signal the capturing of the still picture ends in Operation S610.

FIG. 7 is a flow chart describing an algorithm to capture a moving picture. Referring to FIGS. 1 and 7, the algorithm to capture the moving picture (e.g., Operation S8 in FIG. 3) will now be described by separating it into a first flow and subsequent flows.

In the first flow of the algorithm performed in Operation S8, the CPU of the computer 5 receives data of an odd frame from the video presenter 1 in Operation S81a. Next, in Operation S82a, the CPU of the computer 5 processes, stores and displays the received data of the odd frame while, in a parallel process of Operation S82b, the CPU simultaneously receives data of an even frame adjacent the odd frame. Further, in Operation S81b, which is a parallel process to Operation S81a, the CPU processes data of an even frame.

Subsequent flows through the foregoing operations S81a, S81b, S82a and S82b are repeated in Operation S83 until a capture time, which may be designated by the user, elapses as described hereinafter.

The algorithm to capture a moving picture makes it possible to alternately receive and process the odd frame and even frame, so that the computer 5 can display the moving picture on the monitor 2 simultaneously with storing moving picture data in a folder of a storage medium of the computer 5 designated by the user, by completely receiving and processing video data input from the video presenter 1 at high speed.

FIG. 8 is a flow chart describing in further detail how the moving picture is captured. Operations S81a1, S81a2, and S81a3 of FIG. 8 are included in Operation S81a in FIG. 7. Operations S81b1 through S81b6 of FIG. 8 are included in Operation S81b in FIG. 7. Operations S82a1 through S82a6 of FIG. 8 are included in Operation S82a in FIG. 7. Operations S82b1 through S82b3 of FIG. 8 are included in Operation S82b in FIG. 7. Referring to FIGS. 1, 2, 7, and 8, it will now be described in detail that the moving picture is captured in Operation S8 in FIG. 3.

In receiving data of an odd frame (e.g., Operation S81a of FIG. 7), the CPU of the computer 5 requests data of the odd frame from the microprocessor 101 of the video presenter 1 in Operation S81a1. In response, the microprocessor 101 of the video presenter 1 controls the memory control unit 107 and transmits completed format frame data from the memory control unit 107 to the computer 5 via the USB interface 109. The CPU of the computer 5 receives data of the odd frame from the video presenter 1 and stores frame data in the “Y:Cb:Cr 4:2:2” format in the first buffer in Operations S81a2 and S81a3.

In processing data of an even frame (e.g., Operation S81b of FIG. 7 that occurs simultaneously with Operation S81a) the CPU of the computer 5 converts the frame data in the “Y:Cb:Cr 4:2:2” format stored in the second buffer into frame data in the 24-bit RGB format in Operation S81b1. Next, in Operation S81b2 the CPU of the computer 5 converts the frame data in the 24-bit RGB format into frame data in the DIB format for use in the GDI of the OS of the computer 5. The CPU of the computer 5 then in Operation S81b3 outputs the frame data in the DIB format to the GDI. The OS of the computer 5 displays the even frame data from the video presenter 1. The CPU of the computer 5 performs Operations S81b2 and S81b3 simultaneously with selective compression of the even frame data, which is in the 24-bit RGB format, in Operations S81b4 and S81b5. The CPU then stores the compressed or uncompressed even frame data in a moving picture file, which may be generated in a folder designated by the user, in Operation S81b6.

Similarly, in processing data of an odd frame (e.g., Operation S82a of FIG. 7), the CPU of the computer 5 converts the frame data in the “Y:Cb:Cr 4:2:2” format stored in the first buffer into the frame data in the 24-bit RGB format in Operation S82a1. The CPU of the computer 5 converts the frame data from the 24-bit RGB format into the DIB format in Operation S82a2 in order to be used in the GDI of the OS of the computer 5.

The CPU of the computer 5 then outputs the frame data in the DIB format to the GDI in Operation S82a3. The OS of the computer 5 displays the odd frame data from the video presenter 1. The CPU of the computer 5 performs Operations S82a2 and S82a3 simultaneously with selective compression of the odd frame data, which is in the 24-bit RGB format, in Operations S82a4 and S82a5. The CPU then stores compressed or uncompressed odd frame data in the moving picture file, which may be generated in the folder designated by the user, in Operation S82a6.

In receiving data of an even frame (e.g., Operation 82b of FIG. 8 that occurs simultaneously with Operation S82a), the CPU of the computer 5 requests data of the even frame from the microprocessor 101 of the video presenter 1 in Operation S82b1. In response, the microprocessor 101 of the video presenter 1 controls the memory control unit 107, and transmits completed format frame data from the memory control unit 107 to the computer 5 via the USB interface 109. The CPU of the computer 5 receives data of the even frame from the video presenter 1, and stores frame data in the “Y:Cb:Cr 4:2:2” format in the second buffer in Operations S82b2 and S82b3.

In Operation S83, all the foregoing described Operations S81a1-S81a3, S81b1-S81b6, S82a1-S82a6 and S82b1-S82b3 are repeated until the capture time, which may be designated by the user, elapses.

According to the method of processing video data, by alternately receiving and processing odd frames and even frames, the receiving speed and processing speed of video data from a video presenter double so that a computer can display and capture a moving picture by completely receiving and processing video data input at a high speed.

While this invention has been particularly shown and described with reference to preferred embodiments thereof, it will be understood by those skilled in the art that various changes in form and details may be made therein without departing from the spirit and scope of the invention as defined by the appended claims. The preferred embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A method of displaying a video data stream including a plurality of alternating odd and even frames received from a video presenter, the method comprising the steps of:
(a) receiving data of a first odd frame from the video data stream;
(b) processing the received data of the first odd frame
(c) substantially simultaneously with step (b), receiving data of a first even frame adjacent said first odd frame;
(d) processing the received data of said first even frame; and
(e) substantially simultaneously with step (d), receiving data of a second odd frame subsequent to said first even frame.

2. The method of claim 1 wherein the receiving steps of (a), (c) and (e) each further comprise:
requesting data of a frame from the video presenter;
detecting receipt of data of the frame; and
storing the data in a buffer when the data of the frame is detected, wherein odd frame data is stored in a first buffer and even frame data is stored in a second buffer.

3. The method of claim 2 wherein the processing steps of (b) and (d) further comprise:
first converting frame data stored in a buffer to a 24-bit RGB format;
second converting the 24-bit RGB format data to a DIB format; and
outputting the DIB format data to a graphic device interface.

4. The method of claim 1 further comprising:
detecting a still picture capture signal; and
capturing a still picture from the video data stream at an instant that the still picture capture signal is detected.

5. The method of claim 4 wherein the capturing step comprises:
requesting a frame data from the video presenter;
first converting the frame data to a 24-bit RGB format;
second converting the frame data in the 24-bit RGB format to a DIB format;
outputting the frame data in the DIB format to a graphic device interface; and
storing the frame data in the DIB format to a frame buffer.

6. The method of claim 5 further comprising:
detecting a storing signal; and
storing the frame data from the frame buffer to a folder at an instant that the storing signal is detected.

7. The method of claim 6 wherein the folder is designated by a user of the video presenter.

8. The method of claim 1 further comprising:
detecting a moving picture capture signal
determining a capture time duration; and
capturing a moving picture from the video data stream at an instant that the moving picture capture signal is detected until the capture time duration has elapsed.

9. The method of claim 8 wherein the capturing step comprises:
substantially simultaneously with the step (b), first determining if the data of the first odd frame is to be compressed;
substantially simultaneously with the step (b), storing the data of the first odd frame, in at least one of a compressed and uncompressed format relative to the first determining step, to a moving picture file;
substantially simultaneously with the step (d), second determining if the data of the first even frame is to be compressed; and
substantially simultaneously with the step (d), storing the data of the first even frame, in at least one of a compressed and uncompressed format relative to the second determining step, to the moving picture file.

10. The method of claim 3 further comprising:
detecting a moving picture capture signal
determining a capture time duration; and
capturing a moving picture from the video data stream at an instant that the moving picture capture signal is detected until the capture time duration has elapsed.

11. The method of claim 10 wherein the capturing step comprises:
substantially simultaneously with the second converting step, first determining if the frame data in the 24-bit RGB format is to be compressed; and
substantially simultaneously with the second converting step, storing the frame data in the 24-bit RGB format, in at least one of a compressed and uncompressed format relative to the first determining step, to a moving picture file.

12. The method of claim 11 wherein the moving picture file is stored in a folder is designated by a user of the video presenter.

13. A method for displaying a high-speed video signal from a video presenter that communicates with a computer linked with a display, the method comprising:
initializing the computer for communication with the video presenter;
receiving a light at the video presenter that is reflected from a subject;
converting the light at the video presenter to a video data including a plurality of frame units;
storing the plurality of frame units to a memory of the video presenter;
at the computer, requesting a first frame unit from the video presenter;
storing the first frame unit in a first buffer of the video presenter;
first converting the first frame unit in the first buffer to a first format;
second converting the first frame unit in the first buffer from the first format to a second format;
outputting the first frame unit to a graphic device interface linked with the display
substantially simultaneously with the first and second converting steps, requesting a second frame unit adjacent the first frame unit from the video presenter; and
substantially simultaneously with the outputting step, storing the second frame unit in a second buffer of the video presenter.

14. The method of claim 13 wherein the first format is a 24-bit RGB format.

15. The method of claim 13 wherein the second format is a DIB format

16. The method of claim 13 further comprising:
at the computer, detecting a still picture capture signal; and
storing at least one frame unit from said first and second buffers to a memory at an instant that the still picture capture signal is detected.

17. The method of claim 16 wherein the storing step comprises:
associating the memory with a user-designated folder in the computer; and
copying the at least one frame unit to the user-designated folder.

18. The method of claim 13 further comprising:
at the computer, detecting a moving picture capture signal; and
continuously storing a plurality of frame units from said first and second buffers to a memory starting at an instant that the moving picture capture signal is detected.

19. The method of claim 18 further comprising:
determining a capture time duration;
timing the storing step; and
terminating the storing step when the capture time duration is determined to have elapsed relative to the timing step.

20. A system for presenting video data, the system comprising:
a video presenter comprising an optical system, a photoelectric converter in communication with the optical system, a signal processing unit linked with the photoelectric converter, a digital camera processor, a frame memory, a microprocessor and a first serial communication interface; and
a computer comprising a central processing unit executing a video data processing program and including a first buffer and a second buffer, a memory, a second serial communication interface and a graphic device interface,
wherein, the optical system receives a light that is converted to a video signal by the photoelectric converter in cooperation with the digital camera processor, the digital camera processor storing the video signal in the frame memory, so that when the video presenter and the computer are linked by an interconnection means between the first and second serial communication interfaces the central processing unit requests a first frame from the microprocessor, stores the first frame in the first buffer, processes the first frame and outputs the first frame from the first buffer to the graphical device interface, and while the central processing unit processes and outputs the first frame the central processing unit also requests a second frame adjacent the first frame and stores said second frame to the second buffer.
